(19) United States
(12) Patent Application Publication
(10) Pub. No.: US 2003/0079385 A1
(43) Pub. Date: May 1, 2003

(54) Multi-image,3-dimensional novelty items

(76) Inventors: Wynne Noble, Brooklyn, NY (US); Eileen W. Noble, Brooklyn, NY (US)

Correspondence Address: Frank J. DeRosa, Brown Raysman Millstein Felder & Steiner LLP, 900 Thrid Avenue, New York, NY, 10022, US

(21) Appl. No.: 10/032,830

(22) Filed: Oct. 25, 2001

(51) Int. Cl. G09F 19/14

(52) U.S. Cl. 40/453

(57) ABSTRACT

Enclosures, containers and 3-dimensional novelty items and toys that present two or more composite graphic images or sets of images when viewing an item from different directions. The novelty items can also perform another function, such as pencil holder, drinking cup, building block, paper weight, notebook, etc. The invention thereby provides an entertainment or enjoyment value, or commercial value (e.g., advertising, marketing, promotional) in addition to any other utility of the item. For example, the graphic images can be those of licensed characters, such as those available from The Walt Disney Company and Warner Brothers, for example, or text or a message. An observer can view a first image or set of images on the novelty item from a first direction and second image or set of images on the novelty item from a second direction.

### BACKGROUND OF THE INVENTION

The invention generally relates to enclosure, containers and 3-dimensional novelty items and toys that display graphics, messages, etc..

### SUMMARY OF INVENTION

The invention provides enclosures, containers and 3-dimensional novelty items and toys that present two or more composite graphic images or sets of images when viewing an item from different directions. Unless the context indicates otherwise, :item” and “toy” are used interchangeably herein, and item may refer to an enclosure or container unless the context indicates otherwise. “Image” or “images” are used herein in a broad sense, and encompass images of persons, places, things, characters, figures, graphic designs and abstracts, text, messages, etc., or parts thereof. In the preferred embodiments, the novelty items also perform another function, such as pencil holder, drinking cup, building block, paper weight, notebook, etc. The invention thereby provides an entertainment or enjoyment value, or commercial value (e.g., advertising, marketing, promotional) in addition to any other utility of the item. For example, the graphic images can be those of licensed characters, such as those available from The Walt Disney Company and Warner Brothers, for example, or text or a message. The images may also have a personal or other relationship with the holder or provider of the item. Items incorporating the invention may therefore be provided for many purposes, including personalization, enjoyment, entertainment, marketing, advertising, promotional and/or novelty purposes.

The invention provides the two or more graphic images or sets of images, when the item is viewed by an observer from different directions. “Direction” as used in a broad sense and encompasses linear directions as well as directions along a curve, and clockwise and counter-clockwise directions. The item comprises, on all or part of an exterior viewable side or region, at least two interleaved series or sets of sections arranged in a wave-like manner such that each present a composite image or a set of images. The sections of each series of interleaved sections generally face in a common direction so that images or parts of images displayed by the sections of a same series are viewable together, and the sections of different series face in different directions. In a preferred embodiment, individual sections of the first series and individual sections of the second series are alternatingly interspersed with the adjacent edges of the sections being parallel. Preferably all or a substantial number of the edges of the sections in the series are parallel.

An observer can view a first image or set of images on the item from a first direction and second image or set of images on the item from a second direction. For example, the sections of one series of sections may display a composite image of Mickey Mouse, while the sections of another series of sections may display a composite image of Donald Duck, or the sections may display messages, or combinations of graphic objects such as cartoon characters and messages, etc.

As mentioned, the items are 3-dimensional and in cross section form, for example, closed figures. A closed figure may be a geometric figure such as polygon, or a tube or other curved figure. In the case of a polygon, each exterior and/or interior side may be provided with the series of sections described above. In the case of a tubular or other curved figure, all or part of the exterior and/or interior curved figure is provided with the series of sections. In the case of a notebook, the series of sections are provided as a cover to the notebook.

Preferred embodiments provide 3-dimensional items in the form of enclosures and containers or vessels such as pencil holders, drinking cups and nestable toys, etc., as well as closed items such as toy blocks and paperweights.

The wave-like series of sections may be exposed, and thereby provide an undulating surface, or closed by a smooth wall or sheet-like member, or sandwiched between smooth walls or sheet-like members to present a smooth surface. The 3-dimensional figures may be closed on one or more sides, i.e., open on one but less than all sides. A pencil holder or drinking cup, for example, is open at one end of tubular item. When the sections are closed or sandwiched by sheet-like members, such members are transparent or translucent.

The invention also provides a novelty item or toy in the form of nestable or stackable blocks, each having on at least one side the wave-like structure described above.

The blocks may be constructed with a rectangular cross-sectional profile, in which case the pitch and angle between adjacent sections is preferably substantially identical for all the blocks in the set in order to allow them to cleanly interlock with one another. The blocks may alternatively be constructed with a cylindrical cross-sectional profile, in which case the angle between adjacent sections is substantially identical for all the blocks in the set in order to allow them to cleanly interlock with one another

The side-wall of each block may alternatively be constructed with smooth inner and outer walls that are spaced apart from one another and sandwich a wave-like structure therebetween. As discussed above, the walls may be transparent or translucent.

### BRIEF DESCRIPTION OF THE DRAWINGS

The foregoing and other aspects of the invention will become more apparent from the following description of illustrative embodiments thereof and the accompanying drawings which illustrate the invention by way of example. In the drawings:

FIG. 1A is an isometric view of a container according to a first embodiment;

FIG. 1B is a top view of the first embodiment;

FIG. 2A is an isometric view of a container according to a second embodiment;

FIG. 2B is a top view according to the second embodiment;

FIG. 3 is a plan view of an adhesive sheet;

FIG. 4A is an isometric view of a toy block according to a third embodiment;

FIG. 4B is a plan view of a set of three nestable toy blocks, a representative sample of which is shown in FIG. 4A;

FIG. 5A is an isometric view of a cylindrical toy block according to a fourth embodiment;

FIG. 5B is a plan view of a set of three nestable cylindrical toy blocks, a representative sample of which is shown in FIG. 4A; and

FIG. 6 is an isometric view of a notebook according to a fifth embodiment.

### DETAILED DESCRIPTION OF PREFERRED EMBODIMENTS

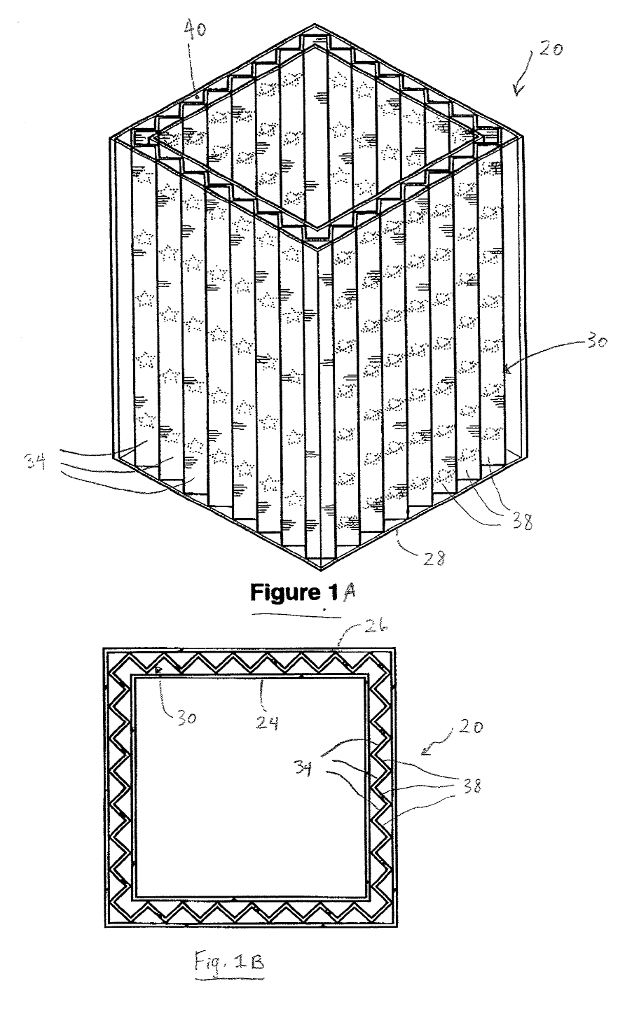

FIGS. 1A and B illustrate a container 20 according to a first embodiment of the invention which can be used as a pencil holder. The container 20 has a rectangular cross-sectional profile and comprises a sidewall constructed from spaced-apart inner and outer walls 24 and 26, and a bottom wall 24. The container 20 has an open top, but may be closed by a wall similar to wall 24. Alternatively, the top and/or bottom may be closed by a wall similar to a sidewall 24 which includes a wave-like structure 30 described below. In those embodiments, the item can be used as a toy block or paperweight. The inner and outer walls are preferably fabricated from plastic, such as acrylic. The outer wall 26 is transparent or translucent and the inner wall 24 is preferably transparent or translucent too, but it need not be. The bottom wall 28 also need not be transparent or translucent.

A wave-like structure 30 is disposed between the inner and outer walls 24 and 26. The structure 30 has two interleaved series of sections 34 and 38, each of which is faces in a different direction. The first series of sections 34 is preferably imprinted with or otherwise carries graphics that form a first composite image or set of images. This image or image set, or at least portions thereof, can be coherently viewed from a first direction of observation, as exemplified by the pattern of planets shown on display sections 34. The second series of sections 38 is preferably imprinted with or otherwise carries graphics that form a second composite image or set of images. This image or image set or at least portions thereof, can be coherently viewed from a second direction of observation, as exemplified by the pattern of stars shown on display sections 38.

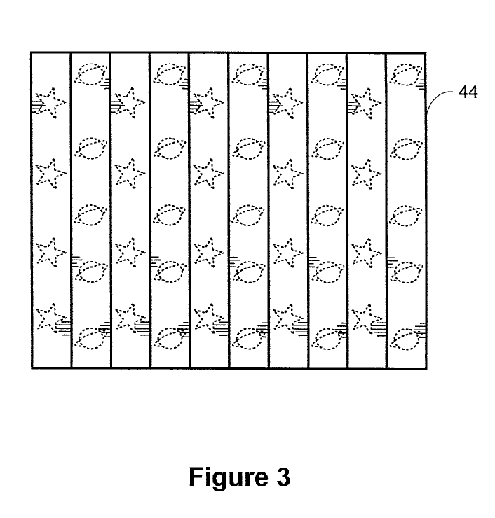

The wave-like structure 30 is preferably sealed within the inner and outer walls 24 and 28 via a top lip or end cap 40. As such, the first and second images are preferably pre-printed or pre-applied on the wave-like structure 30. However, the end cap 40 can also be removeably secured to the inner and outer walls 24 and 26, e.g., by a friction fit, allowing the wave-like structure 30 to be replaced with a another one if desired. The wave-like structure 30 may be constructed out of any material suitable for receiving graphics, such as cardboard or plastic. In addition, the graphics may be provided on an adhesive backed paper 44, as exemplified in FIG. 3, which can be applied by the user. A kit of such parts may also be provided for sale.

For best visual effects, the sections in each series 34, 38 are preferably of equal size and arranged parallel to each other, with the sections of one series being orientated transversely (preferably about 30 to 60 degrees) to the sections of the other series.

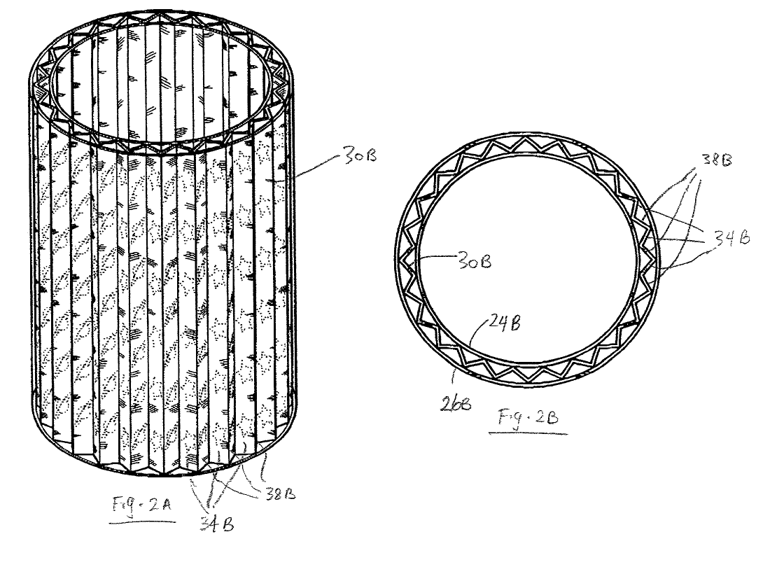

FIGS. 2A and 2B illustrate a container 50 according to a second embodiment of the invention which can be used as described above for the container 20. Container 50 is tubular, and is otherwise similar to container 20 described above, in both an open top and fully closed form. The inner and outer walls 24B, 26B and wave-like structure 30B of container 50 have a circular cross-sectional profile but the item 50 is otherwise similar to the item 20. For best visual effects, the sections in each series 34B and 38B of the wave-like structure 30B are preferably of equal size and arranged equidistantly along a circumference defined by the inner and outer walls 24B, 26B. In addition, the edges of adjacent sections are preferably parallel to each other, i.e., the lines formed by the intersection of the planes defining sections 34B and 38B are parallel to one another.

The undulating wave-like structure encased in the walls of container 20 or 50 of items 20 and 50 provides an eye-catching display area suitable for character merchandising. For example, the first and second images can include popular cartoon characters. The container may be sized to function as a pencil or toothbrush holder, or may be made larger for uses such as a waste receptacle. The containers also have utility as novelty items per se.

In alternative embodiments, the inner and outer walls 24 and 26 (or 24B and 26B) may be eliminated and replaced with a single undulating sidewall upon which the graphics constituting the composite images may be imprinted. An example of this is presented below.

FIG. 3 depicts a wave-like structure 44, which is configured similar to wave-like structure 30 but may have a planer bottom, not shown. Wave-like structure 44 is rigid, but may flex, and generally maintains its configuration. The top of structure 44 has images as described above. The bottom has an adhesive backing covered by a peelable protective sheet. After removing the protective sheet, the structure 44 may be affixed to various surfaces and things, such as wearing apparel, refrigerator doors, etc.

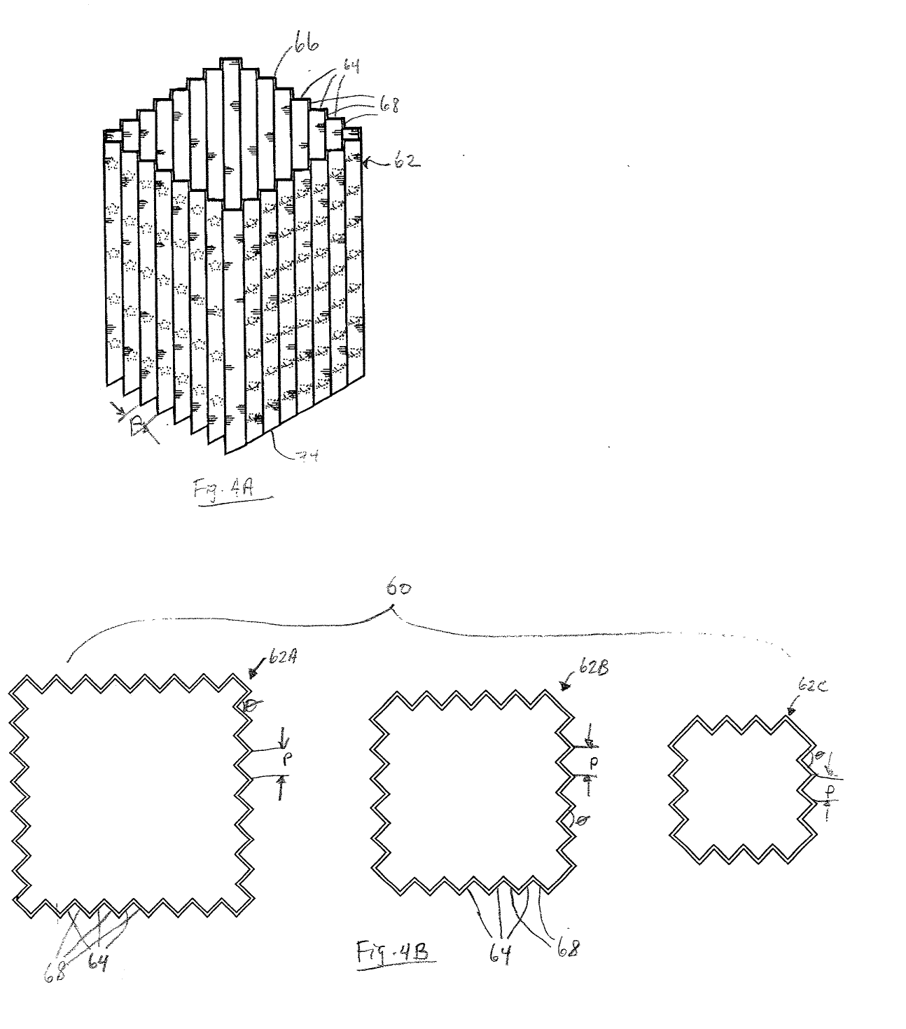

FIG. 4A shows an enclosure 62 according to a third embodiment, which may be open at both ends or closed at either or both ends. In the closed embodiment, the enclosure 62 may be used as a toy block or paper weight. In the embodiment in which the enclosure 62 is open at one or both ends, the enclosure may be nested with other similar enclosures. FIG. 4B depicts a set of rectangular blocks 62A, 62B and 62C, where each block is sized somewhat larger or smaller than the other blocks in the set, so that the blocks can be nested. FIG. 4A shows one of the blocks in perspective view with an open top; this block is representative of any block in the set except for dimensions. FIG. 4B shows the set of blocks in plan view. The illustrated set includes three blocks, but any number greater than one will suffice. Each block 62 has a side-wall 66 that undulates in a triangular manner so as to define two interleaved series of planar sections 64 and 68, each of which is disposed in a different direction. The first series of sections 64 is preferably imprinted with or otherwise carries graphics that form a first composite image, and the second series of sections 68 is preferably imprinted with or otherwise carries graphics that form a second composite image. For best visual effects, the sections in each series 64 and 68 are preferably of equal size and arranged parallel to each other, with the sections of one series being orientated transversely to the sections of the other series.

In the illustrated embodiment, a bottom wall 74 of each block may also feature, or omit, an undulating surface as described above. In the illustrated embodiment the blocks are open-ended (i.e., five-sided volumes) so as to enable the blocks to nest into one another. However, the blocks may alternatively be close-ended (i.e., six-sided volumes) with all surfaces being undulated.

The wave-like surfaces of all the blocks in a set preferably have identical pitch (p) and angle (θ) measurements so as to enable the blocks to cleanly interlock with one another when the wave-like surfaces of the blocks are stacked one on top of the other. The larger blocks have a greater number of sections 64, 68 along a given side than the smaller blocks.

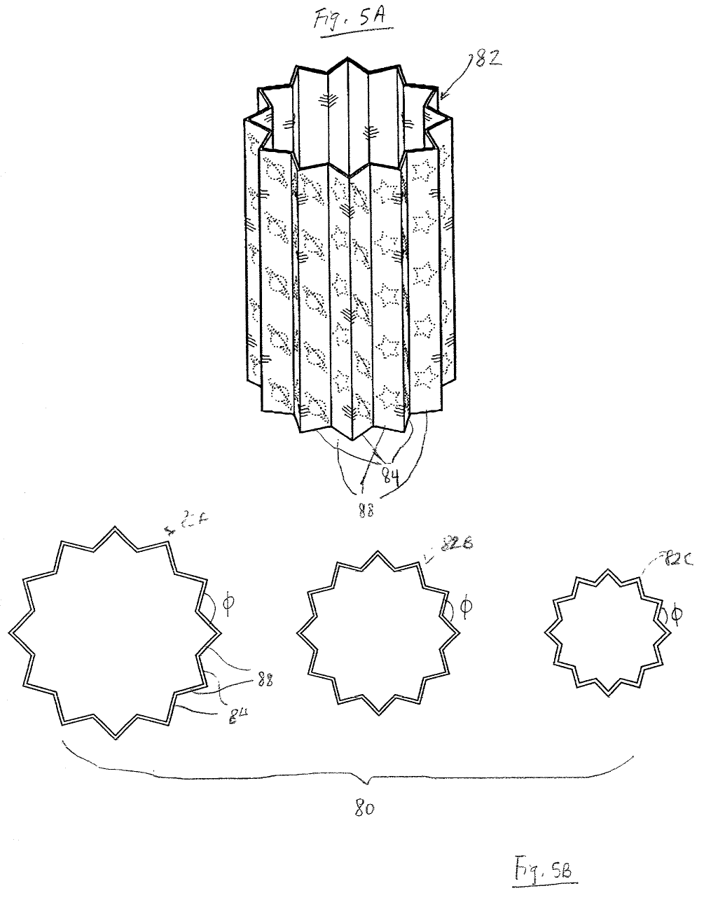

FIG. 4A shows an enclosure 82 according to a fourth embodiment, similar to enclosure 62 except that it is cylindrical. Enclosure 82 may be open at both ends or closed at either or both ends. FIG. 5B shows a set of cylindrical blocks 82A, 82B and 82C, where each block is sized somewhat larger or smaller than the other blocks in the set. FIG. 5A shows one of the blocks in perspective view; this block is open at the top and is representative of any block in the set except for dimensions. FIG. 5B shows the set of blocks in plan view. Each block 82 has a side-wall surface that undulates in a triangular manner so as to define two interleaved series of planar sections 84 and 88 along the circumference of the cylindrical block. Each section is disposed in a different direction, similar to the blocks 62 described above, with the angle (φ) formed between adjacent sections 84 and 88 being preferably selected from the range of 20 to 70 degrees, and most preferably about 45 degrees. In this case, in order to allow the blocks 82 to cleanly interlock with one another, the angle (φ) formed between adjacent sections 84 and 88 is preferably identical for each block in the set. The blocks 82 may be closed-ended or open-ended, in which case the blocks 82 may be nested. The ends closing the item 82 may be undulated or flat.

In either embodiment, the blocks 60 or 80 provide an eye-catching design with undulating surfaces suitable for receiving graphics. The toys can thus be suitable for character merchandising.

In alternative embodiments, the surface of the blocks can be formed from a double-walled structure with a wave-like structure disposed between the walls in a manner similar to the double-walled structure of container 20 or 50.

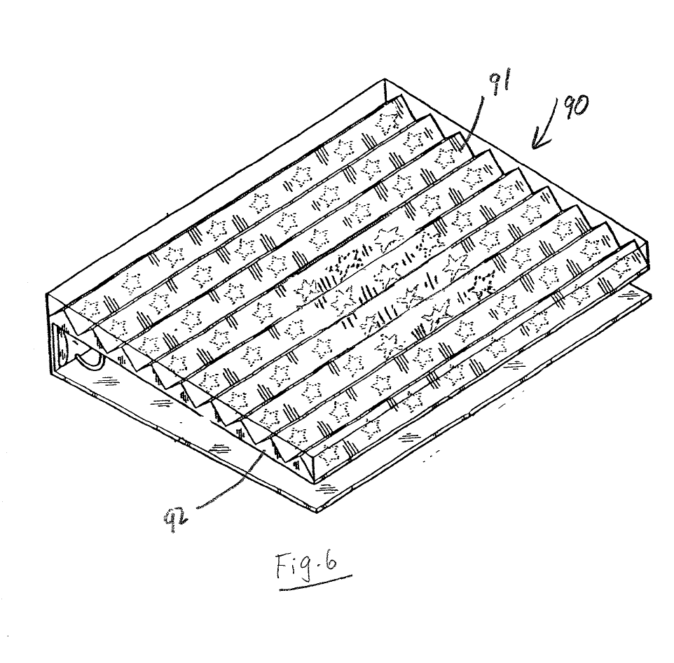

FIG. 6 depicts a notebook 90 having a wave-like structure 91, similar to the wave-like structure 30 described above, serving as a notebook cover. The wave-like structure 91 may be secured to the cover 92 in any suitable manner. In the embodiment depicted in FIG. 6, the wave-like structure 91 is covered by a transparent enclosure 94, which may be made of any suitable plastic, attached to the notebook cover 92. The enclosure 94 has some rigidity to provide some protection to the wave-like structure 91 as may be encountered in normal use. However, in another embodiment (not shown) the enclosure 94 is omitted. FIG. 6 depicts embodiments in which a wave-like structure is secured to only one cover of the notebook. However, wave-like structures 91 may be secured to both covers, as well as to the spine of the notebook.

The foregoing descriptions of specific embodiments of the present invention have been presented for purposes of illustration and description. They are not intended to be exhaustive or to limit the invention to the precise forms disclosed, and obviously many modifications and variations are possible in light of the disclosure herein. Those skilled in the art will appreciate that many modifications and variations may be made to the embodiments described herein without departing from the spirit or scope of the invention. The applicant intends that the claims cover all such modifications and variations, and equivalents thereof, permitted by the prior art.

1. An enclosure defined by one or more walls, at least one of which comprises a wave-like surface having two interleaved series of sections, each of said series being disposed in a different direction, one series of sections bearing graphics for display of a first composite image viewable from a first direction and the other series of sections bearing graphics for display of a second composite image viewable from a second direction.

2. The enclosure of claim 1 configured as a container having an opening thereto.

3. The enclosure of claim 1 defined by sidewalls closing the enclosure on all sides.

4. The enclosure of claim 1 defined by sidewalls providing opposed openings to the enclosure.

5. The enclosure of claim 1 wherein the at least one sidewall undulates so as to provide the wave-like surface.

6. The enclosure of claim 1, wherein the at least one sidewall comprises:
inner and outer walls spaced apart from one another; and
a wave-like structure disposed between the spaced-apart walls which provides said wave-like surface bearing said graphics.

7. The enclosure of claim 6, wherein at least a portion of the outer wall is translucent to thereby enable said wave-like structure to be viewed.

8. A container, comprising:
a bottom wall;
inner and outer walls spaced apart from one another and integrally joined with the bottom wall, the outer wall being at least partially translucent; and
a wave-like structure disposed between the two walls, the wave-like structure having two interleaved series of sections, each of said series being disposed in a different direction, one series of sections bearing graphics for display of a first composite image viewable from a first angle of observation and the other series of sections bearing graphics for display of a second composite image viewable from a second angle of observation.

9. A set of two or more blocks, each block in the set being differently sized;
wherein each block includes at least a sidewall including a wave-like surface having two interleaved series of sections, each of said series being disposed in a different direction, one series of sections bearing graphics for display of a first composite image viewable from a first angle of observation and the other series of sections bearing graphics for display of a second composite image viewable from a second angle of observation.

10. The set of claim 9, wherein each block has a rectangular cross-sectional profile, and the pitch and angle between adjacent sections is substantially identical for all the blocks in the set.

11. The set of claim 9, wherein each block has a cylindrical cross-sectional profile, and the angle between adjacent sections is substantially identical for all the blocks in the set.

12. The set of claim 6, wherein the side-wall of each block includes:
inner and outer walls spaced apart from one another, the outer wall being at least partially translucent; and
a wave-like structure disposed between the spaced-apart walls which provides said wave-like surface bearing said graphics.

13. A notebook comprising having at least one cover and a wave-like structure secured to the at least one cover, the wave-like structure comprising:
at least two series of interleaved sections arranged in a wave-like manner so that sections of each series are viewable by an observer from at least one direction and sections of respective series are viewable from at least one respective direction different from a direction from which sections of another series are viewable; and
graphics on a plurality of sections of each set, the graphics defining a composite image or a plurality of related images that are viewable from the respective direction;

14. A 3-dimensional item comprising:
arranged in a tube, at least two series of interleaved sections arranged in a wave-like manner so that sections of each series are viewable by an observer from at least one direction and sections of respective series are viewable from at least one respective direction different from a direction from which sections of another series are viewable, graphics on a plurality of sections of each series, the graphics defining a composite image or a plurality of related images that are viewable from the respective direction; and
means for supporting the tube in a self-standing manner.

15. A 3-dimensional item, comprising:
first, second, third and fourth wave-like structures, each having:
at least two series of interleaved sections arranged in a wave-like manner so that each section of a respective series is viewable by an observer from at least one direction and sections of respective series are viewable from at least one respective direction different from a direction from which sections of another series are viewable, graphics on a plurality of sections of each series, the graphics defining a composite image or a plurality of related images that are viewable from the respective direction; and
means for supporting the sections in a self-standing manner in an adjacent relationship to from an enclosure with each wave-like structure substantially exposed for viewing.

16. The item according to claim 15 wherein the wave-like structures are joined at adjacent edges.
